(19) United States
(12) Patent Application Publication
(10) Pub. No.: US 2014/0230017 A1
(43) Pub. Date: Aug. 14, 2014

(54) PROGRAMMABLE SECURITY TOKEN

(71) Applicant: APPSENSE LIMITED, Warrington (GB)

(72) Inventor: Joseph SAIB, Santa Clara, CA (US)

(73) Assignee: APPSENSE LIMITED, Warrington (GB)

(21) Appl. No.: 13/765,159

(22) Filed: Feb. 12, 2013

(51) Int. Cl. G06F 21/30

(52) U.S. Cl. CPC G06F 21/30
USPC 726/4

(57) ABSTRACT

Systems and methods are described for programmable security token. A programmable security token includes an input interface configured to receive post-vendor customization of a parameter used to generate a security code, an authorization module configured to authorize the post-vendor customization, a configuration module configured to perform the post-vendor customization when the post-vendor customization is authorized, an execution module configured to generate the security code using at least the customized parameter, wherein the security code is suitable for an authentication server, and an output interface configured to output the generated security code.

### BACKGROUND

Security and authentication in computer systems is of utmost importance, especially during the information age in networked environments. One common approach is to require a user to enter a user ID and password pair to authenticate the user. For enhanced security, additional information, such as a security code, can be required for authentication. A security code can be generated by a security token, which can be based on software or/hardware. A hardware security token can, for example, be a physical device that generates security codes automatically or on demand. A hardware security token can be either connected to or disconnected from a host system into which the security code needs to be entered.

Security tokens (either software or hardware) today are generally configured by the manufacturer/vendor. Once a customer or user receives a security token from the vendor, it cannot be modified or programmed. In some situations, however, customers (e.g., a corporation IT team) may prefer the ability to customize the security tokens received from the vender, e.g., for enhanced security or improved flexibility.

### SUMMARY

Disclosed subject matter includes, in one aspect, a programmable security token, which includes an input interface configured to receive post-vendor customization of a parameter used to generate a security code, an authorization module configured to authorize the post-vendor customization, a configuration module configured to perform the post-vendor customization when the post-vendor customization is authorized, an execution module configured to generate the security code using at least the customized parameter, wherein the security code is suitable for an authentication server, and an output interface configured to output the generated security code.

In some embodiments, the parameter is one of a certificate, an algorithm, a seed, or a random number.

In some other embodiments, the programmable security token further includes a certificate module configured to manage a certificate used to generate the security code, an algorithm module configure to manage an algorithm used to generate the security code, a seed module configured to manage a seed used to generate the security code, and a random number module configured to generate a random number used to generate the security code.

In some other embodiments, the authorization module is further configured to authorize the post-vendor customization if an authorization certificate is received at the input interface.

In some other embodiments, the authorization certificate is a passcode.

In some other embodiments, the authorization module is further configured to authorize the post-vendor customization a single time only.

In some other embodiments, the input interface is in the form of a wired connection.

In some other embodiments, the input interface is in the form of a wireless connection.

In some other embodiments, the parameter is a certificate that is associated with a different authentication server.

Disclosed subject matter includes, in another aspect, a computerized method of using a programmable security token, which includes receiving, at the programmable security token, a request to customize a parameter used to generate a security code, determining whether the request to customize the parameter is authorized, performing the post-vendor customization of the parameter as a function of whether the request is authorized, generating a security code using at least the customized parameter, outputting the generated security code, and transmitting the generated security code to an authentication server according to the customization of the parameter.

In some embodiments, the parameter is one of a certificate, an algorithm, a seed, or a random number.

In some other embodiments, the computerized method of using a programmable security token further includes authorizing the post-vendor customization if an authorization certificate is received.

In some other embodiments, the authorization certificate is a passcode.

In some other embodiments, the computerized method of using a programmable security token further includes prohibiting the post-vendor customization after a previous post-vendor customization has been performed.

Disclosed subject matter includes, in yet another aspect, a programmable security token, which includes a housing, an input interface configured to receive post-vendor customization of a parameter used to generate a security code, a power source positioned inside the housing configured to provide power to the programmable security token, a non-transitory computer readable medium positioned inside the housing and having executable instructions, a processor positioned inside the housing and configured to execute the executable instructions to: authorize the post-vendor customization of the parameter, perform the post-vendor customization of the parameter, and generate the security code using at least the customized parameter, and an output interface configured to output the generated security code.

In some embodiments, the parameter is one of a certificate, an algorithm, a seed, or a random number.

In some other embodiments, the executable instructions are further operable to cause the processor to authorize the post-vendor customization when an authorization certificate is received.

In some other embodiments, the authorization certificate is a passcode.

In some other embodiments, the executable instructions are further operable to cause the processor prohibit the post-vendor customization after a previous post-vendor customization has been performed.

Various embodiments of the subject matter disclosed herein can provide one or more of the following capabilities. A programmable security token can provide post-vendor customization for the customers or users. A programmable security token can provide enhanced security and/or improved flexibility. For example, a programmable security token can allow post-vendor configuration of its certificate, seed, and/or algorithm, etc.; a programmable security token can allow authentication by different authentication servers; and a programmable security token can also create opportunities for value-added-resellers to provide additional customization to end-users of the security tokens.

These and other capabilities of embodiments of the disclosed subject matter will be more fully understood after a review of the following figures, detailed description, and claims.

### BRIEF DESCRIPTION OF THE DRAWINGS

FIG. 1 illustrates a diagram of an exemplary networked communication system.

FIG. 2 illustrates a block diagram of an exemplary authentication system in accordance with certain embodiments of the disclosed subject matter.

FIG. 3 illustrates an exemplary process of authentication in accordance with certain embodiments of the disclosed subject matter.

FIG. 4 illustrates an exemplary programmable security token in accordance with certain embodiments of the disclosed subject matter.

FIG. 5 illustrates an exemplary operation of authentication in accordance with certain embodiments of the disclosed subject matter.

FIG. 6 illustrates a schematic diagram of an exemplary programmable security token in accordance with certain embodiments of the disclosed subject matter.

### DETAILED DESCRIPTION

In the following description, numerous specific details are set forth regarding the systems and methods of the disclosed subject matter and the environment in which such systems and methods can operate, etc., in order to provide a thorough understanding of the disclosed subject matter. It will be apparent to one skilled in the art, however, that the disclosed subject matter can be practiced without such specific details, and that certain features, which are well known in the art, are not described in detail in order to avoid complication of the subject matter of the disclosed subject matter. In addition, it will be understood that the embodiments described below are only examples, and that it is contemplated that there are other systems and methods that are within the scope of the disclosed subject matter.

Embodiments of the disclosed subject matter can support post-vendor customization for the customers or users of security tokens. In one exemplary use of programmable security tokens, a corporate IT team purchases programmable security tokens from a vendor for use by the corporate users. The programmable security tokens received from the vendor can already contain a built-in security certificate and a default security code generation algorithm. The corporate IT team usually would need to purchase or lease an authentication server from the same vendor, since these security tokens are usually configured to be used only with an authentication server from the same vendor.

Once the corporate IT team receives the security tokens, the corporate IT team can program the security tokens so that the security tokens have customized security certificate and/or security code algorithm. The customization can provide enhanced security and/or improved flexibility. The corporate IT team can also configure the security tokens so that a different authentication server can be used instead of or in addition to the ones from the same vendor that provides the security tokens. These customizations can improve flexibility and potentially lower cost of operation. The customization can be done through an input interface of the security tokens. The input interface can be wired, such as an USB connection, or wireless, such as a WI-FI connection. The customization can require an extra layer of security/authentication. For example, the corporate IT team can be required to enter a configuration authorization code provided by the security token vendor before it can program the security token. In another example, the security token can only be programmed once after it leaves the control of the vendor (e.g., after shipment).

In some situations, a programmable security token can be programmed by an authorized user (e.g., a corporate IT team) then distributed to the end-users (e.g., regular corporate users); in some other situations, the authorization user of programmable security tokens can be a value-added-reseller of security tokens. The value-added-reseller can program the security tokens to perform customization, which can fit the needs of the customers of the value-added-reseller, and then sell the customized security tokens its customers (e.g., end-users). Other embodiments are within the scope of the disclosed subject matter.

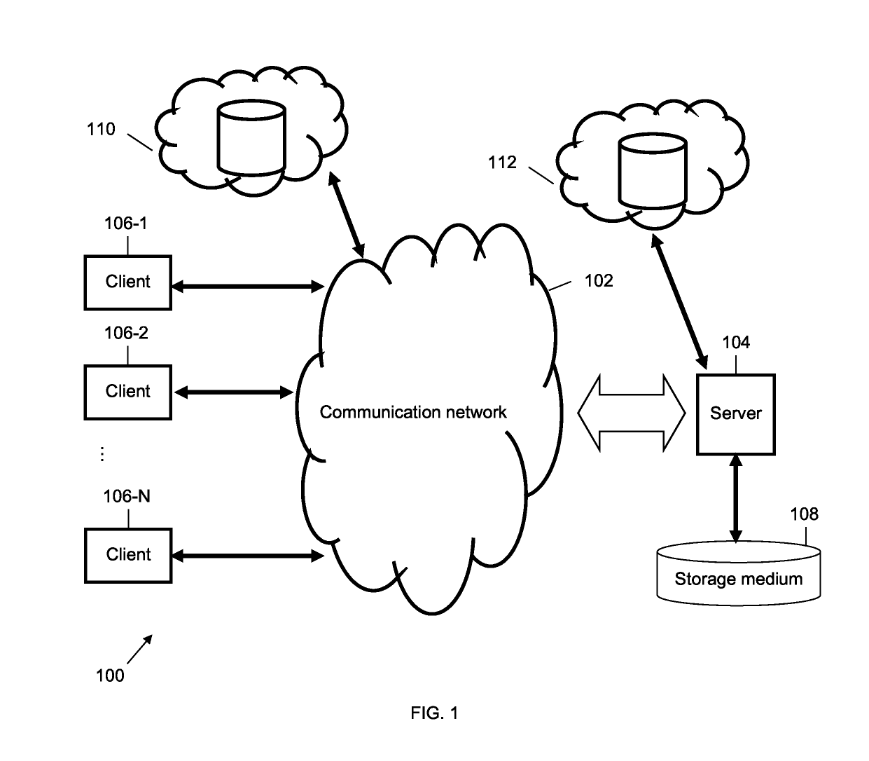

Embodiments of the disclosed subject matter can be implemented in a networked computing system. FIG. 1 illustrates a diagram of an exemplary networked communication arrangement 100 in accordance with an embodiment of the disclosed subject matter. The networked communication arrangement 100 can include a server 104, at least one client 106 (e.g., client 106-1, 106-2, . . . 106-N), a physical storage medium 108, and a cloud storage 110 and 112, which can all be coupled, directly or indirectly to a communication network 102.

Each client 106 can communicate with the server 104 to send data to, and receive data from, the server 104 across the communication network 102. Each client 106 can be directly coupled to the server 104. Alternatively, each client 106 can be connected to server 104 via any other suitable device, communication network, or combination thereof. For example, each client 106 can be coupled to the server 104 via one or more routers, switches, access points, and/or communication network (as described below in connection with communication network 102). A client 106 can include, for example, a desktop computer, a mobile computer, a tablet computer, a cellular device, a gaming console, a smartphone, or any computing systems that are capable of performing computation.

Server 104 can be coupled to at least one physical storage medium 108, which can be configured to store data for the server 104. Preferably, any client 106 can store data in, and access data from, the physical storage medium 108 via the server 104. FIG. 1 shows the server 104 and the physical storage medium 108 as separate components; however, the server 104 and physical storage medium 108 can be combined together. FIG. 1 also shows the server 104 as a single server; however, server 104 can include more than one server. FIG. 1 shows the physical storage medium 108 as a single physical storage medium; however, physical storage medium 108 can include more than one physical storage medium. The physical storage medium 108 can be located in the same physical location as the server 104, at a remote location, or any other suitable location or combination of locations.

FIG. 1 shows two embodiments of a cloud storage 110 and 112. Cloud storage 110 and/or 112 can store data from physical storage medium 108 with the same restrictions, security measures, authentication measures, policies, and other features associated with the physical storage medium 108. FIG. 1 shows the cloud storage 112 separate from the communication network 102; however, cloud storage 112 can be part of communication network 102 or another communication network. The server 104 can use only cloud storage 110, only cloud storage 112, or both cloud storages 110 and 112. While, FIG. 1 shows one cloud storage 110 and one cloud storage 112, more than one cloud storage 110 and/or more than one cloud storage 112 or any suitable combination thereof can be used.

The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks can be implemented with any number of hardware and software components, transmission media and network protocols. FIG. 1 shows the network 102 as a single network; however, the network 102 can include multiple interconnected networks listed above.

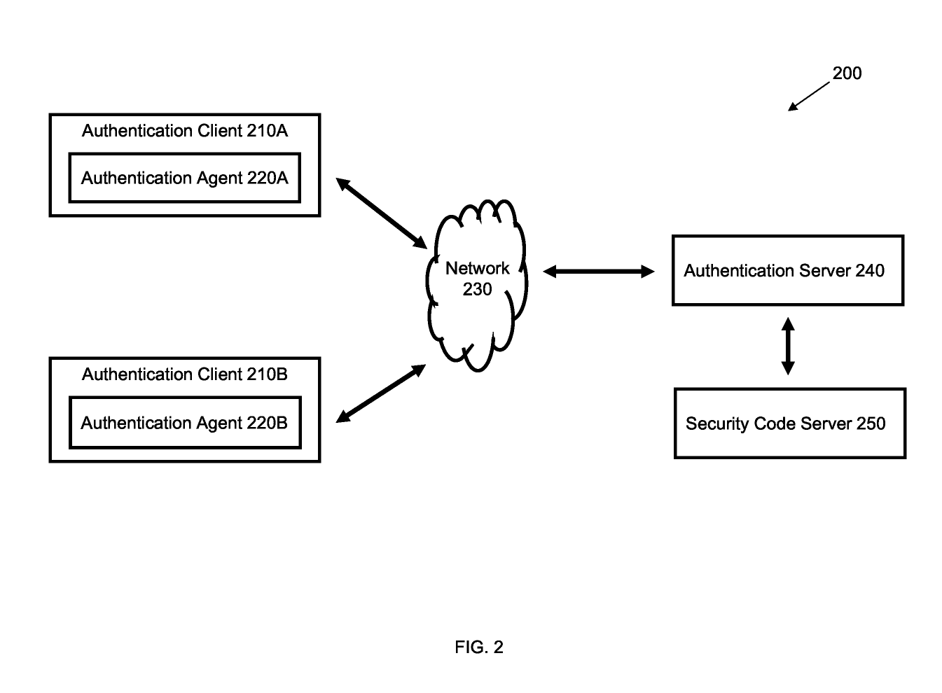

FIG. 2 illustrates a block diagram of an exemplary authentication system 200 in accordance with certain embodiments of the disclosed subject matter. Using the authentication system 200, a user can be authenticated, for example, for accessing system resources (e.g., logging into a bank account). The authentication system 200 can include one or more authentication clients 210A and 210B, an authentication server 240, and a network 230. The authentication system 200 can further include a security code server 250. The authentication clients 210A and 210B, the authentication server 240, and the security code server 250 can be directly or indirectly coupled to the network 230 and communicate among each other via the network 230, which can be wired, wireless, or a combination of both.

The authentication client 210A or 210B, like each client 106 illustrated in FIG. 1, can include a desktop computer, a mobile computer, a tablet computer, a cellular device, a gaming console, a smartphone, or any computing systems that are capable of performing computation. The authentication server 240 can also include a desktop computer, a mobile computer, a tablet computer, a cellular device, a gaming console, a smartphone, or any computing systems that are capable of performing computation. The security code server 250 can be operated, controlled, or associated with the same entity that operates, controls, or is associated with the authentication server 240; alternatively, the security code server 250 can be operated, controlled, or associated with a third party. Although FIG. 2 shows the authentication server 240 as a single server, the authentication server 240 can include more than one physical and/or logical servers. The network 230, like the communication network 102 illustrated in FIG. 1, can include the Internet, a cellular network, a telephone network, a computer network, a packet switching network, a line switching network, a local area network (LAN), a wide area network (WAN), a global area network, a corporate network, an intranet, a virtual network, or any number of private networks currently referred to as an Intranet, and/or any other network or combination of networks that can accommodate data communication. Such networks can be implemented with any number of hardware and software components, transmission media and network protocols. FIG. 2 shows the network 230 as a single network; however, the network 230 can include multiple interconnected networks listed above.

Each authentication client 210A or 210B can include an authentication agent 220A or 220B. An authentication agent can help facilitate its associated authentication client in the authentication process. For example, the authentication can provide partial or complete login information (e.g., a login ID or a security code) to the authentication client. The authentication agent 220 can be embedded inside the authentication client 210 as a software module, a hardware component, or a combination of both. Alternatively, the authentication agent 220 can also be separate from but coupled to the authentication client 210. In addition, the authentication agent 220 can also be completely separate from the authentication client 210. In this case, information (e.g., a security code) can be manually retrieved from the authentication agent 220 and input into the authentication client 210. One example of authentication agents is a security token, which can be in software, hardware, or a combination of software and hardware.

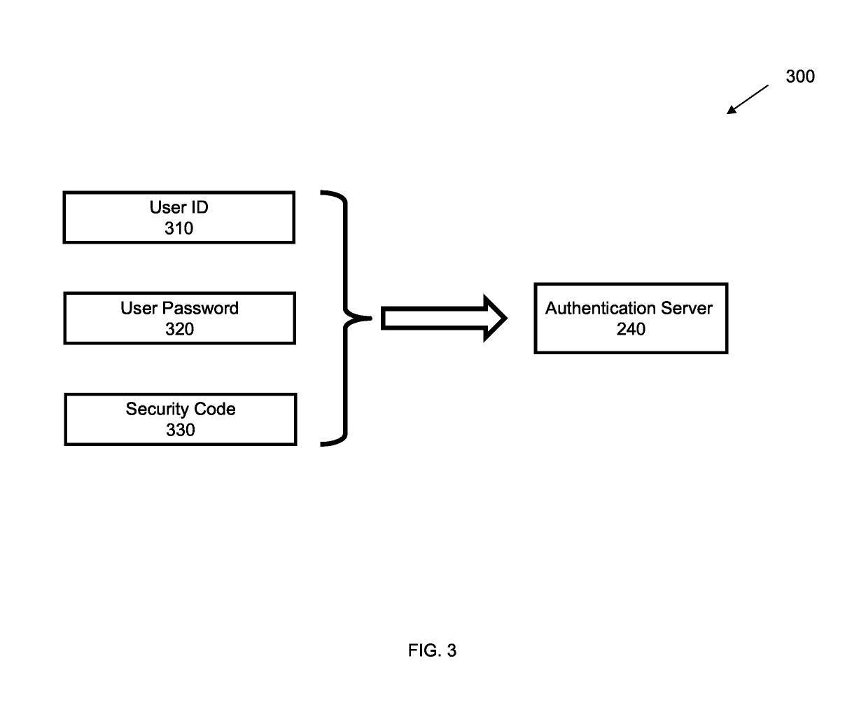

FIG. 3 illustrates an exemplary process 300 of authentication in accordance with certain embodiments of the disclosed subject matter. This process can be used by a user when, for example, he/she tries to access certain system resources (e.g., logging into a bank account). Traditionally, a user ID and password pair can be entered (e.g., at one of the authentication clients 210) and sent to an authentication server for authentication. The user ID and password information can be encrypted before they are sent to the authentication server. This traditional approach may be relatively weak if the user ID and/or password is compromised. For enhanced security, some improved mechanism, such as two-factor authentication, can be adopted. Two-factor authentication normally requires the use of two of the three authentication factors. The three authentication factors can include: (1) something the user knows (e.g., password); (2) something the user has (e.g., security token); and (3) something the user is (e.g., biometric characteristic, such as a fingerprint). FIG. 3 demonstrates one example of a two-factor authentication scheme. In particular, authentication can require something the user knows (e.g., user ID 310 and user password 320) and something the user has (e.g., security code 330 from a security token the user possesses). All three pieces of information (i.e., user ID 310, user password 320, and security code 330) can be sent to the authentication server 240, e.g., via a network.

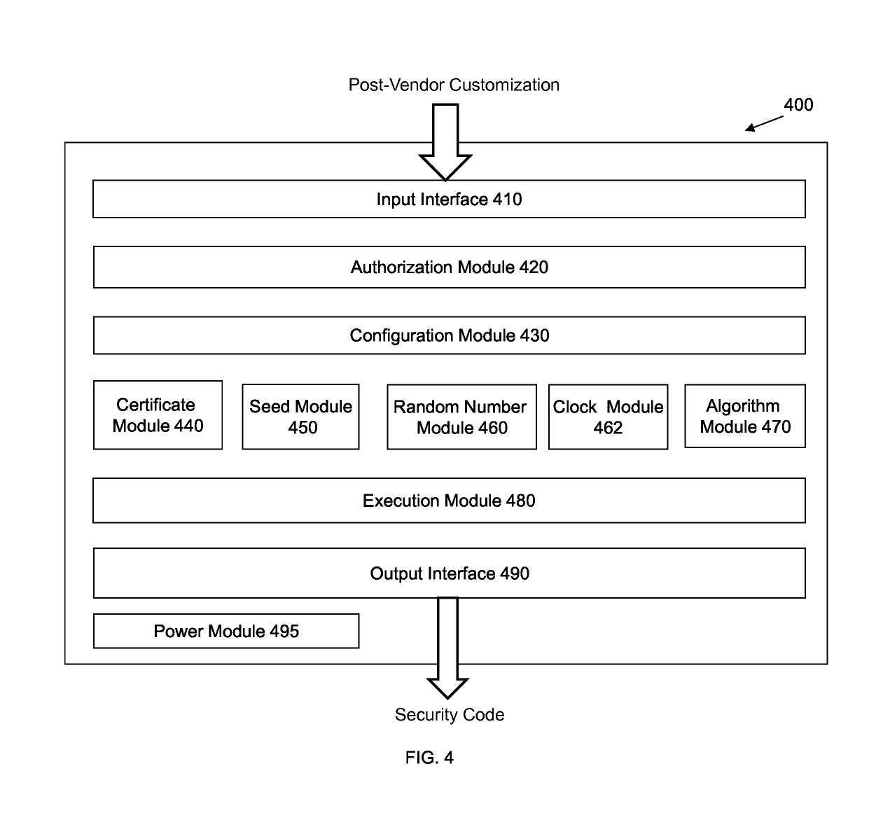

FIG. 4 illustrates an exemplary programmable security token 400 in accordance with certain embodiments of the disclosed subject matter. The programmable security token can be a hardware device or a software component, or a combination of both. The programmable exemplary security token 400 can include an input interface 410, an authorization module 420, a configuration module 430, a certificate module 440, a seed module 450, a random number module 460, a clock module 462, an algorithm module 470, an execution module 480, an output interface 490, and a power module 495. In one example, the programmable security token 400 in FIG. 4 can generate the security code 330 used in the exemplary process of authentication 300 in FIG. 3.

The input interface 410 can receive configuration information (e.g., post-vendor customization). The configuration information can come from an authorized user, such as a corporate IT team. The configuration information can be customized to fit individual needs, such as a security policy of a particular corporation. The input interface can be in software, hardware, or a combination of both. The input interface can be a wired interface, such as a USB connection. Alternatively, the input interface can be a wireless interface, such as a Wi-Fi connection. The input interface 410 can also be any other mechanism by which information to be provided to the security token 400 (e.g., a keyboard, etc.)

The authorization module 420 can help provide security measures to the programming security token 400. The authorization module 420 can check the post-vendor customization and verify whether the post-vendor customization is authorized. In one embodiment, the programmable security token 400 can be associated with an authorization certificate (e.g., an authorization code). The authorization certificate can be provided to an authorization user (e.g., a corporate IT team) by the vendor/manufacturer of the security token. The authorization certificate (e.g., an authorization code) can be entered into the programmable security token for authorization before the post-vendor customization; alternatively, the authorization certificate can be entered into the programmable security token along with the post-vendor customization. If the authorization certificate is authenticated, the post-vendor customization can be accepted for further processing; otherwise, the post-vendor customization can be rejected and the programmable security token can remain intact. In another embodiment, the programmable security token 400 can be manufactured to allow for a one-time post-vendor customization. In other words, the programmable security token 400 can be programmed only once after it is manufactured and shipped by the manufacturer/vendor. For example, when a corporate IT team receives a programmable security token from the vendor/manufacturer, the corporate IT team can perform the one-time post-vendor customization to customize the programmable security token. Once the one-time customization is performed, the programmable security token can become non-programmable and can then be distributed to the end-users.

The configuration module 430 can configure features of the programmable security token 400 based on the post-vendor customization received via the input interface 410. Generation of a security code can take multiple inputs, such as a certificate, a seed, and a random number, etc. These inputs can be fed into an algorithm to generate a security code. The configuration module 430 can update/program the certificate, the seed, how the random number is generated, and the algorithm used for generating security codes.

The certificate module 440 can manage one or more certificates which can be part of the parameters in generating security code. In some situations, the certificate can be the same among all security tokens from the same manufacturer/vendor. In some other situations, the certificate can be different among the security tokens from the same manufacturer/vender but the same among all security tokens associated with the same customer (e.g., a corporation). In some other situations, the certificate can be unique in each security token. As discussed above, the configuration module 430 can interact with the certificate module 440 to update the certificate(s).

The seed module 450 can manage one or more seeds which can be part of the parameters in generating security code. The seed can be unique to each security token. The seed can be preset based on a policy of the manufacturer/vendor or the customer. Alternatively, the seed can be randomly generated. As discussed above, the configuration module 430 can interact with the seed module 450 to update the seed(s).

The random number module 460 can manage one or more random/pseudorandom numbers which can be part of the parameters in generating security code. The random/pseudorandom number can be generated on a completely random basis or generated based on some other factors (e.g., a clock time). As discussed above, the configuration module 430 can interact with the random/pseudorandom number module 460 to update the random/pseudorandom number(s) or modify how the random/pseudorandom number(s) is/are generated.

The clock module 462 can manage and maintain a system time for the programmable security token. In some embodiments, the clock module 462 can provide a time to the random number module 460 in order for it to generate and maintain a random number. In some embodiments, the clock module 462 can output the time directly to the execution module 480 (discussed in details below) at runtime.

The execution module 480 can execute an algorithm and generate a security code based on multiple parameters, such as a certificate, a seed, and a random number. Since the certificate, the seed, the random number, or the algorithm can be programmed, the security code generation can be customized to provide enhanced security and/or improved flexibility. For example, a corporate IT team can program stock security tokens to use a stronger security code algorithm. In another example, the corporate IT team can program the stock security tokens to use a different/stronger certificate. These customization can make the programmable security tokens suitable for use with a different authorization server or security code server (from the authorization server or security code server associated with the stock security tokens).

The output interface 490 can output generated security codes. In some embodiment, the output interface 490 can be a wired or wireless connection to another device (e.g., a coupled host). Using this connection, a security code can be transmitted to another device to be used in an authentication process. For example, a security code can be wirelessly transmitted to a desktop computer when a user tries to sign onto a secure website. In some other embodiment, the output interface 490 can be a human interface to output the security codes to a user (e.g., a display, a speaker, etc.). For example, the output interface 490 can display an alphanumeric code to a user, that the user then manually enters into a desktop computer when the user tries to sign onto a secure website.

The power module 495 can provide the power to the programmable security token 400. In some embodiment, the power module 495 can be an internal power source, e.g., an embedded battery. In some other embodiment, the power module 495 can be coupled with an external power source (e.g., via a USB connection).

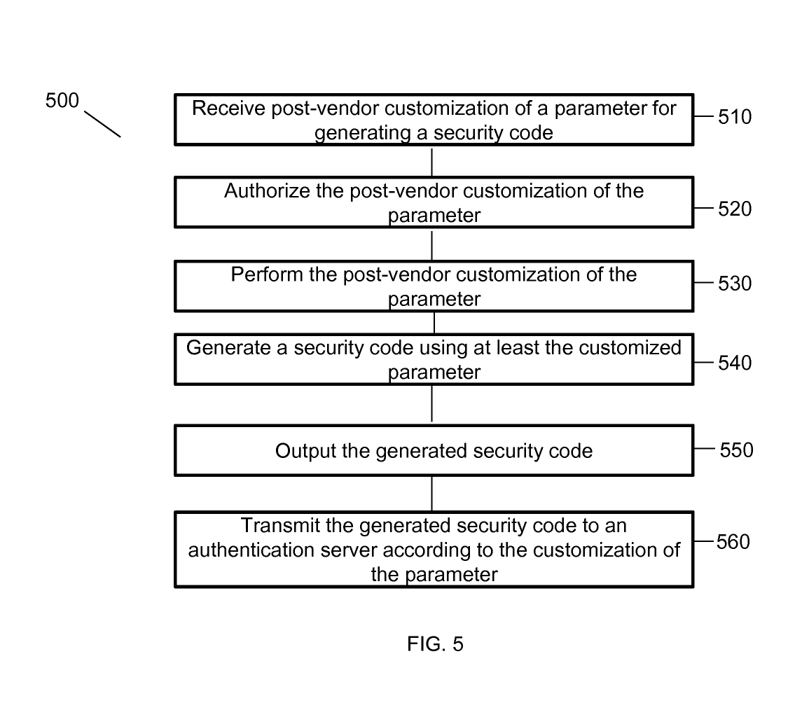

FIG. 5 illustrates an exemplary operation 500 of an authentication process in accordance with certain embodiments of the disclosed subject matter. The operation 500 can be modified by, for example, having stages rearranged, changed, added and/or removed.

At stage 510, a post-vendor customization of a parameter of a parameter for generating a security code can be received, e.g., at the input interface 410. The parameter can include, for example, a certificate, a seed, a random number, and/or an algorithm (e.g., provided by a system administrator).

At stage 520, the post-vendor customization of the parameter can be authorized. In one embodiment, authorization can be a function of an authorization certificate (e.g., an authorization code). The authorization certificate can be provided to an authorization user (e.g., a corporate IT team) by the vendor/manufacturer of the security token. If the authorization certificate is authenticated, the post-vendor customization can be accepted for further processing; otherwise, the post-vendor customization can be rejected and the programmable security token can remain intact. In another embodiment, the authorization can depend on customization history. For example, if the programmable security token has never been customized/programmed after it is shipped out by the manufacturer/vendor, the post-vendor customization can be allowed; otherwise, it can be denied.

At stage 530, the post-vendor customization of the parameter is performed. The parameter is programmed based on the input customization. The parameters can include a certificate, a seed, a random number, and an algorithm. The customization can be done after the programmable security token is manufactured and distributed by the vendor.

At stage 540, a security code can be generated using at least the customized parameter (e.g., at a time when a user is attempting to log onto a secure website). As discussed above, the parameters can include a certificate, a seed, a random number, and an algorithm. The security code can be generated automatically, e.g., based on a fixed scheduled (e.g., every 1 minute). Alternatively, the security code can be generated on-demand, e.g., when a user presses a button.

At stage 550, the generated security code can be output from the programmable security token. The output can be fed directly into a coupled device (e.g., a host device) via a data connection, and/or the output can be directed to a user (e.g., via a display or speaker).

At stage 560, the generated security code can be transmitted to an authentication server. The authentication server can be related to the customized parameter. The authentication server can be different from the one associated with a stock security token without customization.

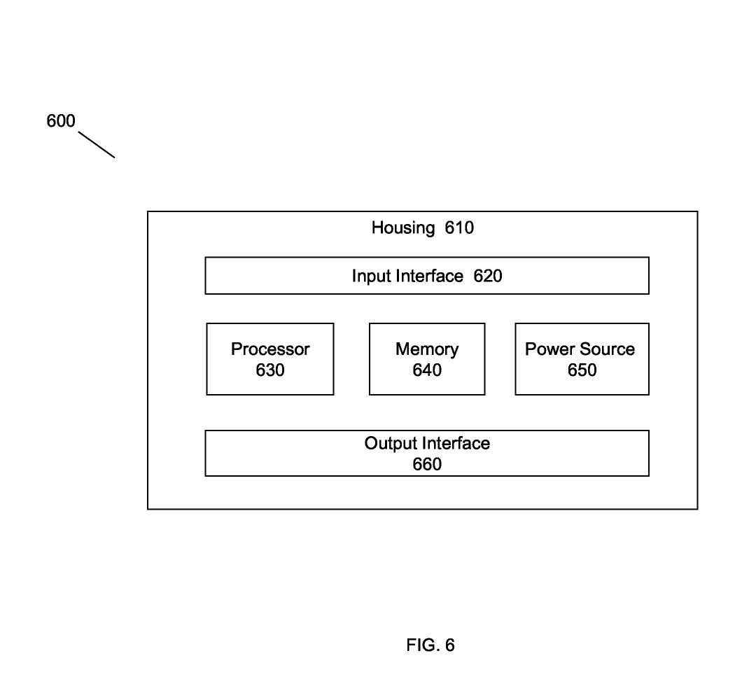

FIG. 6 illustrates a schematic diagram of an exemplary programmable security token in accordance with certain embodiments of the disclosed subject matter. The programmable security token 600 can include a housing 610, an input interface 620, a processor 630, a memory 640, a power source 650, and an output interface 660.

The input interface 620, like the input interface 410 in FIG. 4, can accept post-vendor customization of the programmable security token. The input interface can be in software, hardware, or a combination of both. The input interface can be a wired interface, such as a USB connection. Alternatively, the input interface can be a wireless interface, such as a Wi-Fi connection. The input interface 620 can also be any other mechanism by which information to be provided to the security token 600 (e.g., a keyboard, etc.)

The processor 630 can be hardware that is configured to execute computer readable instructions such as software that are provided from, for example, a non-transitory computer readable medium. The processor 630 can be a general processor or be an application specific hardware (e.g., an application specific integrated circuit (ASIC), programmable logic array (PLA), field programmable gate array (FPGA), or any other integrated circuit). The processor 630 can execute computer instructions or computer code to perform desired tasks. For example, the processor 630 can execute computer instructions to serve as an authorization module, a configuration module, a certificate module, a seed module, a random number module, a clock module, an algorithm module, or an execution module, etc.

The memory 640 can be a transitory or non-transitory computer readable medium, such as flash memory, a magnetic disk drive, an optical drive, a programmable read-only memory (PROM), a read-only memory (ROM), or any other memory or combination of memories. The memory 640 can store a certificate, a seed, a random number, or an algorithm which can be parameters for generating security codes. The memory 640 can also store computer instructions which can be executed by the processor 630 to perform various functions of the programmable security token 600.

The power source 650, like the power module 495 in FIG. 4, can provide power to the programmable security token 600.

The output interface 660, like the out interface 490 in FIG. 4, can output the generated security code.

The programmable security token 600 can include additional modules, fewer modules, or any other suitable combination of modules that perform any suitable operation or combination of operations.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, can readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter can be made without departing from the spirit and scope of the disclosed subject matter, which is limited only by the claims which follow.

A “server,” “client,” “agent,” “module,” “interface,” and “host” is not software per se and includes at least some tangible, non-transitory hardware that is configured to execute computer readable instructions.

What is claimed is:

1. A programmable security token, comprising:
an input interface configured to receive post-vendor customization of a parameter used to generate a security code;
an authorization module configured to authorize the post-vendor customization;
a configuration module configured to perform the post-vendor customization when the post-vendor customization is authorized;
an execution module configured to generate the security code using at least the customized parameter, wherein the security code is suitable for an authentication server; and
an output interface configured to output the generated security code.

2. The programmable security token of claim 1, wherein the parameter is one of a certificate, an algorithm, a seed, or a random number.

3. The programmable security token of claim 1, further comprising:
a certificate module configured to manage a certificate used to generate the security code;
an algorithm module configure to manage an algorithm used to generate the security code;
a seed module configured to manage a seed used to generate the security code; and
a random number module configured to generate a random number used to generate the security code.

4. The programmable security token of claim 1, wherein the authorization module is further configured to authorize the post-vendor customization if an authorization certificate is received at the input interface.

5. The programmable security token of claim 4, wherein the authorization certificate is a passcode.

6. The programmable security token of claim 1, wherein the authorization module is further configured to authorize the post-vendor customization a single time only.

7. The programmable security token of claim 1, wherein the input interface is in the form of a wired connection.

8. The programmable security token of claim 1, wherein the input interface is in the form of a wireless connection.

9. The programmable security token of claim 1, wherein the parameter is a certificate that is associated with a different authentication server.

10. A computerized method of using a programmable security token, comprising:
receiving, at the programmable security token, a request to customize a parameter used to generate a security code;
determining whether the request to customize the parameter is authorized;
performing the post-vendor customization of the parameter as a function of whether the request is authorized;
generating a security code using at least the customized parameter;
outputting the generated security code; and
transmitting the generated security code to an authentication server according to the customization of the parameter.

11. The computerized method of using a programmable security token of claim 10, wherein the parameter is one of a certificate, an algorithm, a seed, or a random number.

12. The computerized method of using a programmable security token of claim 10, further comprising authorizing the post-vendor customization if an authorization certificate is received.

13. The computerized method of using a programmable security token of claim 10, wherein the authorization certificate is a passcode.

14. The computerized method of using a programmable security token of claim 10, further comprising prohibiting the post-vendor customization after a previous post-vendor customization has been performed.

15. A programmable security token, comprising:
a housing;
an input interface configured to receive post-vendor customization of a parameter used to generate a security code;
a power source positioned inside the housing configured to provide power to the programmable security token;
a non-transitory computer readable medium positioned inside the housing and having executable instructions;
a processor positioned inside the housing and configured to execute the executable instructions to:
authorize the post-vendor customization of the parameter;
perform the post-vendor customization of the parameter; and
generate the security code using at least the customized parameter; and
an output interface configured to output the generated security code.

16. The programmable security token of claim 15, wherein the parameter is one of a certificate, an algorithm, a seed, or a random number.

17. The programmable security token of claim 15, wherein the executable instructions are further operable to cause the processor to authorize the post-vendor customization when an authorization certificate is received.

18. The programmable security token of claim 17, wherein the authorization certificate is a passcode.

19. The programmable security token of claim 15, wherein the executable instructions are further operable to cause the processor prohibit the post-vendor customization after a previous post-vendor customization has been performed.
